(19) United States
(12) Patent Application Publication
(10) Pub. No.: US 2016/0073347 A1
(43) Pub. Date: Mar. 10, 2016

(54) Device Proximity Detection Implemented In Hardware

(71) Applicant: Microsoft Corporation, Redmond, WA (US)

(72) Inventors: Alain Luc Michaud, Quebec (CA); Rajesh Philip Roy, Redmond, WA (US); Ellick H. Sung, Seattle, WA (US); Heming Wen, Bellevue, WA (US); Robert Zi Long Zhao, Bellevue, WA (US); Dattatraya B. Rajpure, Redmond, WA (US)

(21) Appl. No.: 14/483,099

(22) Filed: Sep. 10, 2014

(51) Int. Cl. H04W 52/02; H04W 4/00

(52) U.S. Cl. CPC H04W 52/0229; H04W 4/003; H04W 52/0245

(57) ABSTRACT

In embodiments of device proximity detection implemented in hardware, a computing device, such as a mobile phone, appliance device, or other electronic device can be implemented with wireless radio systems for wireless communications, and a wireless radio system receives a wireless signal. A computing device includes a radio controller of the wireless radio system, and the radio controller is implemented to detect an indication associated with the wireless signal, such as a byte pattern in the wireless signal and/or a signal strength of the signal. The radio controller can then determine that the indication of the wireless signal identifies the wireless signal as pertinent to an application executing on the computing device, and communicate an event notice to a signal manager that the wireless signal has been identified. The radio controller communicates event notices via a hardware interface that is implemented to interface the radio controller with the signal manager.

### BACKGROUND

Portable electronic and computing devices, such as mobile phones, tablet computers, multimedia devices, and the like often include multiple, different systems for wireless communications, such as Wi-Fi, Bluetooth™, Near-Field Communication (NFC), and Mobile Broadband. These mobile devices are increasingly challenged to constantly monitor the radio spectrum for wireless signals that may be applicable or useful to a device, and to parse and filter the desired wireless signals. For example, a user may download a mobile application for a particular retail store on his mobile device, and when visiting the retail store, the user can access a map of the particular store layout and receive local advertisements and/or instant coupons that correspond to the retail store while the user is in or proximate the store. These advertisements, coupons, and other communications may be communicated from Wi-Fi access points in the retail store, as Bluetooth™ low-energy beacons, or as other types of wireless signals for communication with the mobile application on the user's mobile device.

However, it is becoming increasingly inefficient for a device processor to be constantly active with the scanning, receiving, filtering, and processing of wireless signals to determine whether each signal is useful to the user of the mobile device, such as whether a wireless signal is applicable to any one of the many mobile applications on the device. Further, the constant scanning and processing of the wireless signals in a mobile device that is battery-powered has power implications, both when the radio systems of the different wireless communications technologies are scanning for wireless signals and when the device processor is processing the wireless signals. Conventional techniques include either not filtering the wireless signals, in which case the device processor is increasingly active to process all of the signal activity, or device-based filtering as designated by the user of the device, in which case the technique does not scale for previously unidentified wireless signals, as well as for wireless signals that cannot be uniquely identified.

### SUMMARY

This Summary introduces features and concepts of device proximity detection implemented in hardware, which is further described below in the Detailed Description and/or shown in the Figures. This Summary should not be considered to describe essential features of the claimed subject matter, nor used to determine or limit the scope of the claimed subject matter.

Device proximity detection implemented in hardware is described. In embodiments, a computing device, such as a mobile phone, tablet computer, appliance device, or other electronic device can be implemented with wireless radio systems for wireless communications, and the wireless radio systems receive wireless signals. A computing device can include a radio controller of a wireless radio system, and the radio controller is implemented to determine that a signal strength of a wireless signal meets or exceeds a signal strength threshold. A wireless signal that meets or exceeds the signal strength threshold can indicate a proximity of the mobile device to a signal source of the wireless signal, such as proximity to an access point or other wireless endpoint connection.

The radio controller is also implemented to detect a detectable content of the wireless signal, such as a byte pattern or other detectable content in the wireless signal. The radio controller can then determine that the detectable content of the wireless signal identifies the wireless signal as pertinent to an application executing on the mobile device. The radio controller can determine that the wireless signal is pertinent to the application based on the detected content within the wireless signal and/or based on the signal strength of the wireless signal. The radio controller can then communicate an event notice that the wireless signal has been identified to a signal manager executing on the mobile device, where the event notice is communicated via a radio system hardware interface that is implemented to interface the radio controller with the signal manager. The event notice that is communicated to the signal manager is effective to activate the signal manager from a power-savings state to process the wireless signal, and the signal manager can then determine whether to route the wireless signal for use by the application.

### BRIEF DESCRIPTION OF THE DRAWINGS

Embodiments of device proximity detection implemented in hardware are described with reference to the following Figures. The same numbers may be used throughout to reference like features and components that are shown in the Figures:

FIG. 1 illustrates an example system in which embodiments of device proximity detection implemented in hardware can be implemented.

FIG. 2 illustrates an example of wireless signal strength monitoring in accordance with one or more embodiments of device proximity detection implemented in hardware.

FIG. 3 illustrates example method(s) of device proximity detection implemented in hardware in accordance with one or more embodiments.

FIG. 4 illustrates an example of a state diagram that shows operational states of a hardware radio controller in accordance with one or more embodiments of device proximity detection implemented in hardware.

FIG. 5 illustrates an example system with an example device that can implement embodiments of device proximity detection implemented in hardware.

### DETAILED DESCRIPTION

Embodiments of device proximity detection implemented in hardware are described and can be implemented to offload wireless signal detection to hardware, such as to a radio controller of a wireless radio system. Computing devices configured for wireless communication can include multiple, different systems, such as Wi-Fi, Bluetooth™, Near-Field Communication (NFC), and Mobile Broadband. For example, a computing device, such as a mobile phone, tablet computer, appliance device, or other portable and/or electronic device can include radio devices, antennas, and chipsets of the different wireless radio systems, as well as a radio controller of each wireless radio system. A radio controller is implemented in hardware and/or firmware, and a radio system hardware interface is designed to interface the radio controller with a signal manager that controls wireless signal processing by an operating system of a computing device.

Without the hardware offload support, the processor of a computing device can be constantly active with the scanning, receiving, filtering, and processing of wireless signals to determine whether each signal is useful to the user of the device, such as whether a wireless signal is applicable to any one of many mobile applications on mobile phone or other portable device. Further, many implementations rely on determining the signal strength of wireless signals as a measure of whether a wireless signal is pertinent to a mobile device and/or to a user of the device. Continually polling the signal strength of a wireless signal from the radio controllers of the wireless radio systems is not practical for computing-device platform background scenarios, such as for a battery-powered mobile device or an appliance device that operates to meet an Energy Star compliance.

In embodiments, the radio system hardware interface is implemented, via which the signal manager can designate patterns of bits (e.g., a byte pattern) in a wireless signal, as well as signal strength thresholds, for the radio controller to detect in wireless signals. Generally, the signal manager can designate a condition of a wireless signal, such as the signal strength or other signal attributes of the wireless signal, for the radio controller to detect in wireless signals. Additionally, the signal manager can designate detectable content of a wireless signal, such as a byte pattern in a wireless signal or other detectable content, that the radio controller can detect in wireless signals. The radio controller of a wireless radio system can detect the condition of a wireless signal and/or the detectable content within the wireless signal as an indication associated with the wireless signal, such as an indication that the wireless signal may be pertinent to an application or other software executing on a device.

The radio controller can receive a wireless signal and determine that the signal strength or other condition of the wireless signal meets or exceeds a signal strength threshold, as designated by the signal manager. A wireless signal that meets or exceeds the signal strength threshold can indicate a proximity of a mobile device to a signal source of the wireless signal, such as an access point or other wireless endpoint connection. The radio controller can also detect a byte pattern or other detectable content in the wireless signal (e.g., signal content of the wireless signal), and then determine that the byte pattern identifies the wireless signal as pertinent to an application executing on the mobile device. The radio controller can then communicate an event notice back to a signal manager via the radio system hardware interface to indicate that the wireless signal has been identified. The event notice that is communicated to the signal manager can be effective to activate the signal manager from a power-savings state to process the wireless signal, and the signal manager can then determine whether to route the wireless signal for use by the application.

While features and concepts of device proximity detection implemented in hardware can be implemented in any number of different devices, systems, networks, environments, and/or configurations, embodiments of device proximity detection implemented in hardware are described in the context of the following example devices, systems, and methods.

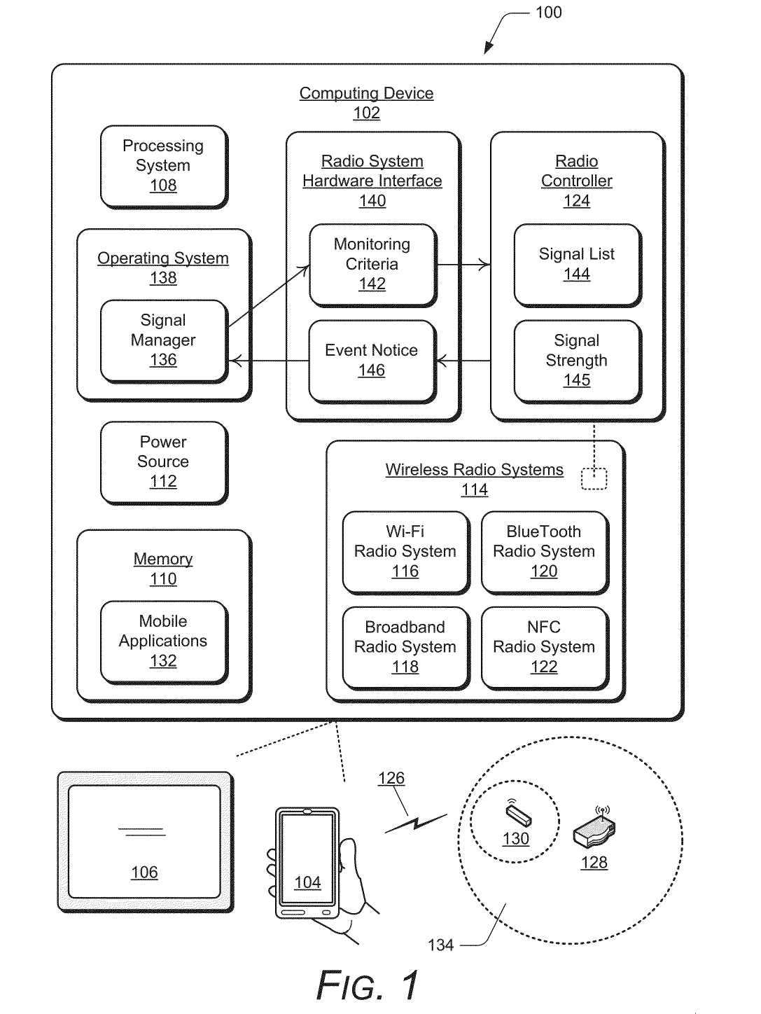

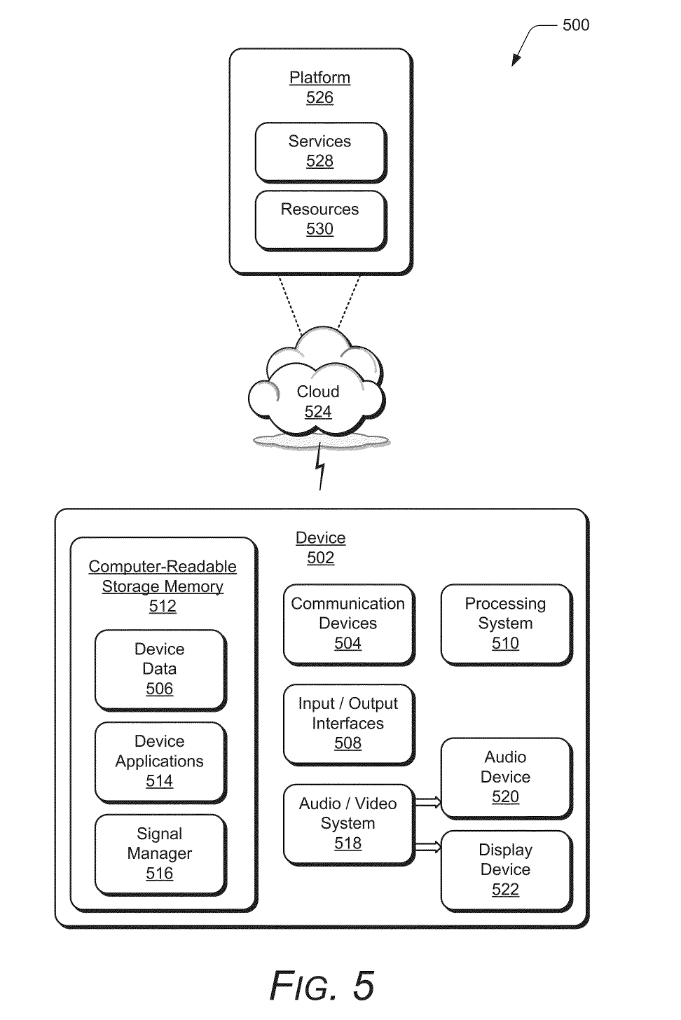

FIG. 1 illustrates an example system 100 in which embodiments of device proximity detection implemented in hardware can be implemented. The example system 100 includes a computing device 102, such as a mobile phone 104, tablet computer 106, or any other appliance, gaming, media playback, entertainment, and/or electronic device that is implemented for wireless communication. The computing device 102 can be implemented with various components, such as a processing system 108 and memory 110, a power source 112 (e.g., a battery) to power device components, and with any number and combination of different components as further described with reference to the example device shown in FIG. 5.

The computing device 102 includes wireless radio systems 114 for multiple, different wireless communications systems, such as for Wi-Fi, Bluetooth™ Mobile Broadband, and Near-Field Communication (NFC). In this example, the computing device 102 includes a Wi-Fi radio system 116, a broadband radio system 118, a Bluetooth™ radio system 120, and an NFC radio system 122. Each of the different radio systems can include a radio device, antenna, and chipset that is implemented for a particular wireless communications technology, as well as a radio controller of each wireless radio system 114. In this example, the computing device includes a radio controller 124 that is representative of the radio controller of any of the wireless radio systems 114.

Generally, when activated or turned-on, the wireless radio systems 114 draw battery power of a battery-powered computing device, such as the mobile phone 104, when scanning for a wireless signal 126 from a wireless endpoint connection, and when communicatively-linked for wireless communication. For example, the radio controller 124 of the Wi-Fi radio system 116 is implemented to scan for wireless signals 126 from Wi-Fi access points that are within communication range, and the Wi-Fi radio system can communicatively-link to an access point 128 for wireless communication via Wi-Fi. Similarly, the radio controller 124 of the Bluetooth™ radio system 120 is implemented to scan for wireless signals 126, such as in the form of low-energy beacons, from Bluetooth™ devices that are within communication range, and the Bluetooth™ radio system 120 can communicatively-link to another Bluetooth™ device 130 for wireless communication.

In implementations, the mobile phone 104 or tablet computer 106 may include mobile applications 132 that are downloaded to the mobile device and stored in the memory 110 on the device. The mobile applications 132 can be any type of device or third-party applications, such as a retail store application, and when visiting or passing nearby the retail store, a user of the mobile phone 104 can receive local advertisements and/or instant coupons that correspond to the retail store while the mobile phone is in or nearby an area 134 that is proximate the store. These advertisements, coupons, and other communications can be communicated as the wireless signals 126 from wireless endpoint connections at the retail store, such as from the access point 128 and/or from the Bluetooth™ device as low-energy beacons, or as other types of wireless signals for communication with the mobile applications 132 on the user's mobile device.

The computing device 102 includes a signal manager 136 that can be implemented as a software application or module, such as executable software instructions (e.g., computer-executable instructions) that are executable with the processing system 108 of the computing device to implement embodiments of device proximity detection implemented in hardware. The signal manager 136 can be stored on computer-readable storage memory (e.g., the memory 110), such as any suitable memory device or electronic data storage implemented by the mobile device. In implementations, the signal manager 136 is a component of the device operating system 138, such as a radio technology functional driver, or can be implemented as part of a wireless technology specific service on the computing device.

Generally, the radio controller 124 is a hardware component that is designed and implemented by the hardware manufacturer of a wireless radio system 114, and the signal manager 136 is a software component designed and implemented by the developer of the operating system 138 on the device. Accordingly, in embodiments of device proximity detection implemented in hardware, a radio system hardware interface 140 is implemented to interface the signal manager 136 with the radio controller 124, and the hardware interface provides hardware offload support for initial wireless signal detection, wireless signal strength determinations, and other signal processing determinations that may otherwise utilize the processing resources of the computing device.

The radio system hardware interface 140 is a host-controller interface that defines interactions between a host (e.g., the computing device 102) and a radio controller 124, such as a Bluetooth™ radio controller of the Bluetooth™ radio system 120. Although the examples are generally described herein with reference to Bluetooth™ (BT), in the context of a radio controller of the BT radio system 120, it should be noted that features of the described techniques for a radio system hardware interface 140 can be similarly implemented for any of the wireless radio systems 114, such as the Wi-Fi radio system 116 and the NFC radio system 122.

In embodiments, the signal manager 136 can receive a list of wireless signals to monitor from the mobile applications 132, the operating system 138, and/or from any other type of application, component, and/or software on the computing device 102. The signal manager 136 is implemented to then communicate monitoring criteria 142 to the radio controller 124 via the radio system hardware interface 140. The signal manager 136 can communicate with firmware of the radio controller 124 via the radio system hardware interface 140. In implementations, the monitoring criteria 142 can include a condition of a wireless signal, such as the signal strength or other signal attributes of the wireless signal, that can be detected when the wireless signal is received by the radio controller. Additionally, the monitoring criteria 142 can include detectable content of a wireless signal, such as a byte pattern that is integrated in the signal. Alternatively or in addition to a specified byte pattern, other detectable content that can be designated by the signal manager 136 and detected in a wireless signal 126 by the radio controller 124 include a specified universally unique identifier (UUID) that can be matched in a received wireless signal; a specified identity resolution key (IRK) used to resolve the private address of the source device from which the wireless signal packet originated; and/or a specified Bluetooth™ address that can be matched in the received wireless signal packet.

The monitoring criteria 142 can also include a signal strength threshold that a wireless signal should meet or exceed when the wireless signal is received. Similarly, the signal strength 145 of a wireless signal 126 may be compared on the basis of being greater than or equal to the signal strength threshold. For example, the received signal strength indication (RSSI) of a wireless signal 126 can be determined by the radio controller 124 of a wireless radio system 114 when the wireless signal is received. In implementations, the monitoring criteria 142 includes the signal strength threshold as various parameters, such as an RSSI high threshold, an RSSI low threshold, an RSSI low threshold time interval, and an RSSI sampling period of the wireless signal.

The radio controller 124 is implemented to receive the monitoring criteria 142 from the signal manager 136 via the radio system hardware interface 140, and maintain the monitoring criteria as part of a signal list 144 that identifies the wireless signals 126 having an identified condition or detectable content to monitor for and detect. In implementations, the Bluetooth™ radio system 120 receives a wireless signal 126, such as in the form of an advertisement received as a low-energy beacon from the Bluetooth™ device 130 in a retail store when a mobile device, such as the mobile phone 104 is in or nearby the area 134 that is proximate the store.

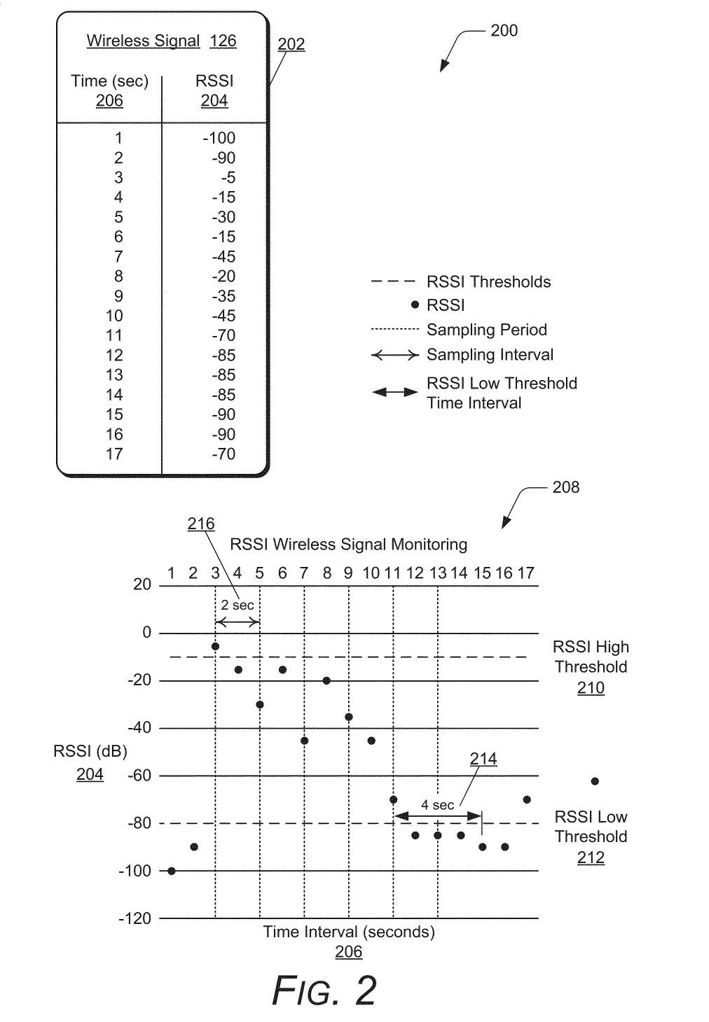

The radio controller 124 is implemented to determine that a signal strength 145 of the wireless signal 126 is greater than or equal to a signal strength threshold, as designated in the monitoring criteria and maintained in the signal list 144. The signal strength 145 of the wireless signal 126 can indicate a proximity of the computing device 102 to the signal source of the wireless signal (e.g., the Bluetooth™ device 130 in this example). Generally, the radio controller 124 can track a wireless signal 126 that is greater than or equal to a signal strength threshold, and may also stop tracking the wireless signal when the signal strength drops below a signal strength threshold. An example of monitoring the RSSI of wireless signals 126 is shown and described with reference to FIG. 2.

In embodiments, the techniques described herein to identify and monitor a wireless signal similarly apply to monitoring wireless connections that have already been established. For example, the radio controller 124 can establish a wireless communication link between a respective wireless radio system 114 and a signal source device for application communication with the signal source device and application processing of the wireless signal. The radio controller implements the connection-based hardware offload support to monitor the established connection between the two wireless devices, such as a wireless connection between the mobile phone 104 and the Bluetooth™ device 130.

FIG. 2 illustrates an example 200 of wireless signal strength monitoring as described with reference to FIG. 1 in embodiments of device proximity detection implemented in hardware. The example 200 includes a table 202 of the RSSI values 204 for a wireless signal 126 received over time intervals 206 (in seconds), and the RSSI values are plotted in a chart 208 over the time intervals. In this example, the RSSI high threshold 210 is −10 db, the RSSI low threshold 212 is −80 db, the RSSI low threshold time interval 214 is three (3) seconds, and the RSSI sampling period 216 is two (2) seconds.

As shown in the example 200, the wireless signal RSSI is greater than the RSSI high threshold 210 at the time interval 206 of three (3) seconds, and a periodic timer for sampling starts at the time interval of three (3) seconds. For every two (2) seconds thereafter, the periodic timer expires and the average RSSI value of the received wireless signal 126 is propagated from the radio controller 124 back to the signal manager 136 via the radio system hardware interface 140. When the periodic timer expires at the time interval of five (5) seconds, the average of the wireless signal RSSIs 204 received during this time (i.e., −23 dB) is propagated to the signal manager. When the periodic timer expires at the time interval of thirteen (13) seconds, the average of the wireless signal RSSIs received during this timeframe is below the RSSI low threshold 212 (−80 dB), and the average of the wireless signal RSSIs (e.g., −85 dB) is propagated to the signal manager. When the RSSI low threshold time interval 214 expires at the time interval of fifteen (15) seconds, the wireless signal 126 is propagated to the signal manager 136 with an RSSI of −85 dB.

Returning to the discussion of FIG. 1, the radio controller 124 is also implemented to detect or identify detectable content in the wireless signal 126 that is received, such as based on a comparison of the wireless signal to the monitoring criteria 142 that is received from the signal manager 136 and maintained in the signal list 144. The radio controller 124 can determine that detectable content within a received wireless signal identifies the wireless signal as pertinent to an application executing on the mobile device, such as pertinent to one of the mobile applications 132, the operating system 138, or pertinent to any other type of application, component, and/or software on the computing device 102.

In implementations, the radio controller 124 can determine a wireless signal 126 as pertinent to an application on the mobile device based on the detected content within the wireless signal and/or based on the signal strength of the wireless signal, as described above. It should also be noted that, although this example describes the radio controller 124 first monitoring the signal strength (e.g., a condition) of the wireless signal 126 and then detecting the detectable content within the received wireless signal, the radio controller can be implemented to first detect or identify the detectable content within the wireless signal and then monitor the signal strength of the wireless signal.

The radio controller 124 can then communicate an event notice 146 back to the signal manager 136 via the radio system hardware interface 140 to indicate that a wireless signal 126 matching the monitoring criteria 142 as designated in the signal list 144 has been identified. For example, the radio controller 124 can determine that the signal strength (e.g., a condition) of the wireless signal is greater than or equal to the signal strength threshold, and/or determine that the detectable content within the wireless signal is an indication that the wireless signal is pertinent to an application or other software executing on the device. If the signal manager 136 is in a powered-down or off state to conserve battery power of the computing device 102, the event notice 146 can be effective to activate the signal manager from a power-savings state to process the wireless signal. The signal manager 136 can receive the event notice 146 that the wireless signal 126 has been identified, and then determine whether to route the wireless signal for use by the application on the mobile device. Further, the radio controller 124 can initiate to establish a wireless communication link for application communication with the signal source device for application processing of the wireless signal.

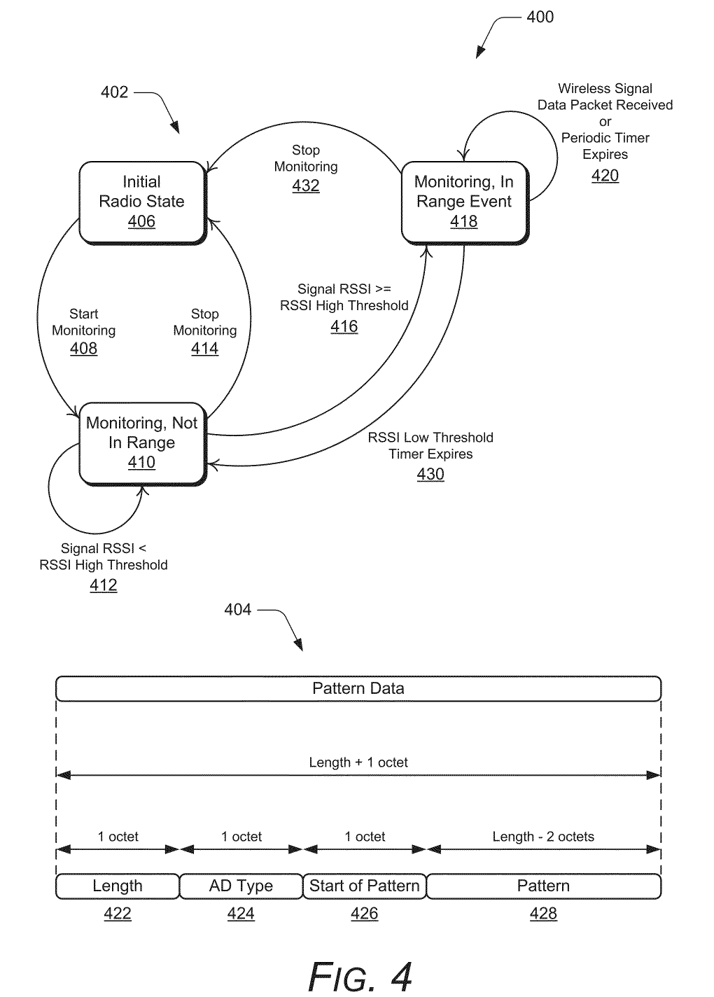

In implementations, the detectable content that is identified in a received wireless signal 126 by the radio controller 124 can be a byte pattern in the wireless signal. A wireless signal 126 can be communicated with a detectable byte pattern that identifies the wireless signal, such as an advertisement, coupon, and/or other wireless signal communication from a wireless endpoint connection in a retail store to the mobile phone 104. For example, a Bluetooth™ low-energy wireless signal can be formatted as a collection of sections that includes a byte pattern to identify the wireless signal as an advertisement. An example of a byte pattern and/or other detectable content that is detectable in a wireless signal is shown and described with reference to FIG. 4.

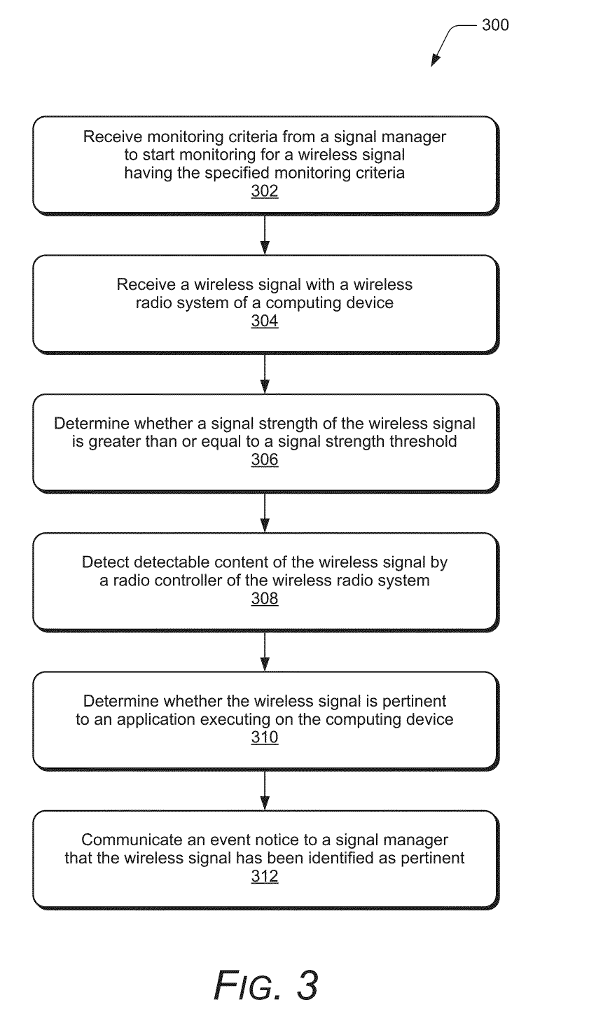

Example method 300 is described with reference to FIG. 3 in accordance with one or more embodiments of device proximity detection implemented in hardware. Generally, any of the components, modules, methods, and operations described herein can be implemented using software, firmware, hardware (e.g., fixed logic circuitry), manual processing, or any combination thereof. Some operations of the example methods may be described in the general context of executable instructions stored on computer-readable storage memory that is local and/or remote to a computer processing system, and implementations can include software applications, programs, functions, and the like. Alternatively or in addition, any of the functionality described herein can be performed, at least in part, by one or more hardware logic components, such as, and without limitation, Field-programmable Gate Arrays (FPGAs), Application-specific Integrated Circuits (ASICs), Application-specific Standard Products (ASSPs), System-on-a-chip systems (SoCs), Complex Programmable Logic Devices (CPLDs), and the like.

FIG. 3 illustrates example method(s) 300 of device proximity detection implemented in hardware, and is generally described with reference to the example system shown in FIG. 1. The order in which the method is described is not intended to be construed as a limitation, and any number or combination of the method operations can be performed in any order to implement a method, or an alternate method.

At 302, monitoring criteria is received from a signal manager to start monitoring for a wireless signal having the specified monitoring criteria. For example, the computing device 102 (FIG. 1) may include the radio controller 124 that can receive the monitoring criteria 142 from the signal manager 136 via the radio system hardware interface 140 that interfaces the radio controller 124 with the signal manager 136. The radio controller 124 maintains the monitoring criteria 142 as part of the signal list 144 that identifies the wireless signals 126 having an indication to monitor for and detect.

The monitoring criteria 142 can include signal strength thresholds that a wireless signal should be greater than or equal to when the wireless signal is received, and can include a condition of a wireless signal, such as the signal strength or other signal attributes, that can be detected when the wireless signal is received. Additionally, the monitoring criteria can include detectable content of a wireless signal, such as a byte pattern in a wireless signal or other detectable content, that the radio controller can detect in wireless signals. Examples of detectable content that can be detected in a wireless signal 126 by the radio controller 124 include a byte pattern of the data, a specified universally unique identifier (UUID), an identity resolution key (IRK) used to resolve the private address of the source device from which the wireless signal originated, and/or a specified Bluetooth™ address that can be matched in the received wireless signal packet.

At 304, a wireless signal is received with a wireless radio system of the computing device. For example, the computing device 102 may include any one or combination of the wireless radio systems 114 that receive wireless signals 126 from compatible signal source devices implemented for wireless communication with the wireless radio systems. The radio controller 124 of the Wi-Fi radio system 116 scans for wireless signals 126 from Wi-Fi access points that are within communication range, such as the access point 128. Similarly, the radio controller 124 of the Bluetooth™ radio system 120 scans for wireless signals 126, such as in the form of low-energy beacons, from Bluetooth™ devices that are within communication range, such as the Bluetooth™ device 130.

At 306, a determination is made with respect to whether a signal strength of the wireless signal is greater than or equal to a signal strength threshold. For example, the radio controller 124 may determine the signal strength 145 of a received wireless signal 126, such as in the form of the received signal strength indication (RSSI) of the wireless signal. The radio controller 124 determines whether the signal strength 145 of the wireless signal 126 is greater than or equal to a signal strength threshold, such as the RSSI high threshold 210. The signal strength 145 of the wireless signal 126 can indicate a proximity of the computing device 102 to the signal source of the wireless signal, and the radio controller 124 tracks the wireless signal that is greater than or equal to the signal strength threshold.

At 308, detectable content of the wireless signal is detected by a radio controller of the wireless radio system. For example, the radio controller 124 may detect or identify detectable content of a received wireless signal 126, such as based on a comparison of the detectable content in the wireless signal to the monitoring criteria 142 that is received from the signal manager 136 and maintained in the signal list 144, such as a byte pattern integrated in the wireless signal, a UUID, an IRK, and/or a specified Bluetooth™ address of a signal source device.

At 310, a determination is made with respect to whether the wireless signal as pertinent to an application executing on the computing device. For example, the radio controller 124 may determine whether the received wireless signal 126 is pertinent to an application based on the signal strength 145 (e.g., a condition) of the wireless signal and/or based on the detected content of the wireless signal, such as based on a comparison of the byte pattern within the wireless signal to the signal list 144 that indicates the wireless signal as being pertinent to the application. The radio controller 124 can determine that the condition and/or detectable content of the received wireless signal identifies the wireless signal as pertinent to one of the mobile applications 132, the operating system 138, or pertinent to any other type of application, component, or software on the computing device 102.

At 312, an event notice is communicated to a signal manager that the wireless signal has been identified as pertinent. For example, the radio controller 124 may communicate the event notice 146 to the signal manager 136 via the radio system hardware interface 140 to indicate that a wireless signal 126 matching the monitoring criteria 142 as designated in the signal list 144 has been identified as pertinent, such as based on the signal strength of the wireless signal being greater than or equal to the signal strength threshold and/or detectable content within the wireless signal being detected. If the signal manager 136 is in a powered-down or off state to conserve battery power of the computing device 102, the event notice 146 is effective to activate the signal manager from a power-savings state to process the wireless signal. The signal manager 136 can receive the event notice 146 that the wireless signal 126 has been identified as pertinent, and then determine whether to route the wireless signal for use by the application on the computing device. Further, the radio controller can then establish a wireless communication link for application communication with the signal source device and application processing of the wireless signal.

FIG. 4 illustrates an example 400 of a state diagram 402 that shows operational transition states of the radio controller 124 and a wireless signal byte pattern 404 as described with reference to FIG. 1 in embodiments of device proximity detection implemented in hardware. In this example, the state diagram 402 includes an initial radio state 406, in which the radio controller 124 is not monitoring for wireless signals of the particular wireless radio system 114 that the radio controller 124 is associated with. In this initial radio state, the radio controller 124 waits to receive a command from the signal manager 136 to begin monitoring for wireless signals that match the monitoring criteria 142.

The radio controller 124 can transition at 408 to start monitoring for wireless signals at a monitoring state 410 of the radio controller 124, such as when the computing device 102 is not within wireless communication range of a wireless endpoint connection or access point. The radio controller 124 of the wireless radio system 114 can monitor for wireless signals 126, and at transition 412, determines that a wireless signal having an RSSI less than the RSSI high threshold 210 is not within adequate communication range. The radio controller 124 may also transition at 414 from the monitoring state 410 back to the initial radio state 406 to stop monitoring for wireless signals.

At the monitoring state 410, the radio controller 124 can determine that a wireless signal 126 has an RSSI that meets or exceeds the RSSI high threshold 210 and transition at 416 to a monitoring, in range state 418 of the radio controller, such as when the computing device 102 is within wireless communication range and the radio controller 124 receives a wireless signal 126 from a wireless endpoint connection. For example, the Bluetooth™ radio system 120 receives a wireless signal 126 in the form of an advertisement received as a low-energy beacon from the Bluetooth™ device 130 in a retail store when the mobile phone 104 is in or nearby the area 134 that is proximate the store.

In conjunction with the transition 416, the radio controller 124 can generate an event notice 146, start a low threshold timer and a periodic timer for the RSSI sampling period, and propagate the received wireless signal to the signal manager 136 on the computing device 102. The radio controller 124 of the wireless radio system 114 can monitor a wireless signal 126 that is within communication range at transition 420. In conjunction with the transition 420, the radio controller 124 can determine that the wireless signal RSSI is greater than the RSSI low threshold 212 and restart the low threshold timer, or determine that the wireless signal RSSI is less than or meets the RSSI low threshold 212 and take no action other than to continue monitoring at the monitoring, in range state 418. Alternatively, the periodic timer may expire at the transition 420, in which case the radio controller 124 can propagate the wireless signal 126 to the signal manager 136 with a reported average RSSI of the wireless signal as received during the sampling period.

Additionally at the monitoring, in range state 418, the radio controller 124 can detect a condition of a wireless signal 126 that is received, such as based on a comparison of the wireless signal to the monitoring criteria 142 that is received from the signal manager 136. A detectable content type parameter specifies the detectable content in a wireless signal as being a byte pattern in the wireless signal, as a universally unique identifier (UUID), an identity resolution key (IRK) used to resolve an address of the source device from which the wireless signal is received, or as a Bluetooth™ address of the source device (e.g., as an example of a Bluetooth™ Low Energy implementation).

If the detectable content of a wireless signal 126 is a byte pattern, then the condition includes sections that contain the number of patterns present within the detectable content and the pattern data. A number-of-patterns parameter is used to designate the number of patterns to be matched and the pattern data is implemented in the format of the wireless signal byte pattern 404. A length 422 specifies the length of the pattern that includes the data type and start byte of the pattern. An advertisement data (AD) type 424 specifies an advertisement type field, in the example of a wireless signal being communicated as an advertisement to the computing device 102. A start-of-pattern 426 specifies the starting byte position of the pattern 428 that immediately follows the AD type. Similarly, there can be a Bluetooth™ Low Energy specific concepts that may apply to other wireless technologies. For instance, Wi-Fi beacons have their own signal packaging structures, as does NFC, neither of which utilizes the AD sections or types.

The wireless signal byte pattern 404 has a size length and is the byte pattern to be matched for the specified AD type 424 within an advertisement packet from the specified start byte. If there are multiple patterns specified, then the radio controller 124 can determine that at least one pattern matches the received wireless signal (e.g., an advertisement in this example). If the condition type parameter specifies a UUID, then the condition parameter contains a UUID type and the UUID, and the UUID type specifies whether the UUID is 16-bit, 32-bit, or 128-bit. The controller parses the service UUID of the advertisement packet to check for the specified UUID. The UUID type can be defined such that the radio controller 124 parses an incomplete list of 16-bit service UUIDs and a complete list of 16-bit service UUIDs specified in the service UUID AD type. Alternatively, the UUID type can be defined such that the radio controller 124 parses an incomplete list of 32-bit service UUIDs and a complete list of 32-bit UUIDs specified in the service UUID AD type. Similarly, the UUID type can be defined such that the radio controller 124 parses an incomplete list of 128-bit service UUIDs and a complete list of 128-bit service UUIDs specified in the service UUID AD type.

If the condition type parameter specifies an IRK, then the condition parameter contains the IRK. If the condition type parameter specifies a Bluetooth™ address, then the condition parameter contains the address type and the Bluetooth™ address. The radio controller 124 is implemented to accept multiple conditions from the signal manager 136, which indicates that the signal manager can send a monitor command to the radio controller when another condition is already pending with the radio controller. The radio controller can refuse a command if another monitor command with the same condition is outstanding. However, the radio controller is implemented not to refuse the command if the condition specifies a Bluetooth™ address and a wireless connection to the mobile device has already been established.

If a wireless signal 126 from a signal source device satisfies the specified condition in the wireless signal and is within communication range when the command to start monitoring is received, then the radio controller 124 waits for the RSSI of the wireless signal to be greater than or equal to the RSSI high threshold before generating an event notice 146 and propagating the wireless signal data packet (e.g., of an advertisement) to the signal manager 136. The radio controller can continue to monitor wireless signals based on the specified conditions even when scanning (active or passive) is enabled. If the radio controller 124 receives a command to start monitoring from the signal manager 136 when the filters are disabled (e.g., based on a previous filter command), then the radio controller can accept the command and set it to a disabled state. The radio controller can also refuse the command for other reasons, like resource exhaustion.

At the monitoring, in range state 418, the radio controller 124 can determine that the low threshold timer expires and transition at 430 back to the monitoring state 410. In conjunction with the transition 430, the radio controller 124 can stop the periodic timer and generate an event notice 146 that is communicated to the signal manager 136 via the radio system hardware interface 140. Alternatively from the monitoring, in range state 418, the radio controller 124 may transition at 432 back to the initial radio state 406 when receiving a command from the signal manager 136 to stop monitoring. In conjunction with the transition 432, the radio controller 124 can stop the periodic timer, stop the low threshold timer, and stop monitoring for wireless signals.

FIG. 5 illustrates an example system 500 that includes an example device 502, which can implement embodiments of device proximity detection implemented in hardware. The example device 502 can be implemented as any of the computing devices described with reference to the previous FIGS. 1-4, such as any type of client device, mobile phone, tablet computer, computing device, communication, entertainment, gaming, media playback, and/or other type of device. For example, the computing device 102, mobile phone 104, and/or the tablet computer 106 shown in FIG. 1 may be implemented as the example device 502.

The device 502 includes communication devices 504 that enable wired and/or wireless communication of device data 506, such as wireless signal monitoring data, wireless signal strength and event notice data, and/or wireless radio systems data. Additionally, the device data can include any type of audio, video, and/or image data. The communication devices 504 can also include transceivers for cellular phone communication and for network data communication.

The device 502 also includes input/output (I/O) interfaces 508, such as data network interfaces that provide connection and/or communication links between the device, data networks, and other devices. The I/O interfaces can be used to couple the device to any type of components, peripherals, and/or accessory devices. The I/O interfaces also include data input ports via which any type of data, media content, and/or inputs can be received, such as user inputs to the device, as well as any type of audio, video, and/or image data received from any content and/or data source.

The device 502 includes a processing system 510 that may be implemented at least partially in hardware, such as with any type of microprocessors, controllers, and the like that process executable instructions. The processing system can include components of an integrated circuit, programmable logic device, a logic device formed using one or more semiconductors, and other implementations in silicon and/or hardware, such as a processor and memory system implemented as a system-on-chip (SoC). Alternatively or in addition, the device can be implemented with any one or combination of software, hardware, firmware, or fixed logic circuitry that may be implemented with processing and control circuits. The device 502 may further include any type of a system bus or other data and command transfer system that couples the various components within the device. A system bus can include any one or combination of different bus structures and architectures, as well as control and data lines.

The device 502 also includes a computer-readable storage memory 512, such as data storage devices that can be accessed by a computing device, and that provide persistent storage of data and executable instructions (e.g., software applications, programs, functions, and the like). Examples of the computer-readable storage memory 512 include volatile memory and non-volatile memory, fixed and removable media devices, and any suitable memory device or electronic data storage that maintains data for computing device access. The computer-readable storage memory can include various implementations of random access memory (RAM), read-only memory (ROM), flash memory, and other types of storage media in various memory device configurations.

The computer-readable storage memory 512 provides storage of the device data 506 and various device applications 514, such as an operating system that is maintained as a software application with the computer-readable storage memory and executed by the processing system 510. In this example, the device applications include a signal manager 516 that implements embodiments of device proximity detection implemented in hardware, such as when the example device 502 is implemented as the computing device 102, the mobile phone 104, or the tablet computer 106 shown in FIG. 1. An example of the signal manager 516 is the signal manager 136 that is implemented by the computing device 102, as described with reference to FIGS. 1-4.

The device 502 also includes an audio and/or video system 518 that generates audio data for an audio device 520 and/or generates display data for a display device 522. The audio device and/or the display device include any devices that process, display, and/or otherwise render audio, video, display, and/or image data. In implementations, the audio device and/or the display device are integrated components of the example device 502. Alternatively, the audio device and/or the display device are external, peripheral components to the example device.

In embodiments, at least part of the techniques described for device proximity detection implemented in hardware may be implemented in a distributed system, such as over a “cloud” 524 in a platform 526. The cloud 524 includes and/or is representative of the platform 526 for services 528 and/or resources 530. The platform 526 abstracts underlying functionality of hardware, such as server devices (e.g., included in the services 528) and/or software resources (e.g., included as the resources 530), and connects the example device 502 with other devices, servers, etc. The resources 530 may also include applications and/or data that can be utilized while computer processing is executed on servers that are remote from the example device 502. Additionally, the services 528 and/or the resources 530 may facilitate subscriber network services, such as over the Internet, a cellular network, or Wi-Fi network. The platform 526 may also serve to abstract and scale resources to service a demand for the resources 530 that are implemented via the platform, such as in an interconnected device embodiment with functionality distributed throughout the system 500. For example, the functionality may be implemented in part at the example device 502 as well as via the platform 526 that abstracts the functionality of the cloud 524.

Although embodiments of device proximity detection implemented in hardware have been described in language specific to features and/or methods, the appended claims are not necessarily limited to the specific features or methods described. Rather, the specific features and methods are disclosed as example implementations of device proximity detection implemented in hardware, and other equivalent features and methods are intended to be within the scope of the appended claims. Further, various different embodiments are described and it is to be appreciated that each described embodiment can be implemented independently or in connection with one or more other described embodiments. Additional aspects of the techniques, features, and/or methods discussed herein relate to one or more of the following embodiments.

A method implemented in a computing device comprises receiving a wireless signal with a wireless radio system in the computing device; detecting at least one indication associated with the wireless signal by a radio controller of the wireless radio system, the at least one indication including detectable content associated with the wireless signal; determining whether the at least one indication associated with the wireless signal identifies the wireless signal as pertinent to an application executing on the computing device; and in response to determining that the at least one indication identifies the wireless signal as pertinent, communicating an event notice to a signal manager.

Alternatively or in addition to the above described method, any one or combination of: receiving monitoring criteria from the signal manager to start monitoring for the wireless signal having the detected at least one indication; the at least one indication comprises the detectable content associated with the wireless signal or a signal strength of the wireless signal, or both; the detectable content associated with the wireless signal comprises a byte pattern in the wireless signal, and the method further comprises comparing the byte pattern to a signal list, wherein the determining that the at least one indication identifies the wireless signal as pertinent at least comprises determining that the byte pattern is included in the signal list; determining whether the signal strength of the wireless signal is greater than or equal to a signal strength threshold, and wherein the determining that the at least one indication identifies the wireless signal as pertinent further comprises determining that the signal strength of the wireless signal is greater than or equal to the signal strength threshold; receiving the signal list from the signal manager via a hardware interface configured to interface the radio controller with the signal manager; the communicating comprises communicating the event notice to the signal manager via the hardware interface effective to activate the signal manager from a power-savings state to process the wireless signal; and determining whether the signal strength of the wireless signal is greater than or equal to a signal strength threshold, wherein the determining that the at least one indication identifies the wireless signal as pertinent at least comprises determining that the signal strength of the wireless signal is greater than or equal to the signal strength threshold.

A computing device comprises a wireless radio system configured to receive a wireless signal; and a radio controller of the wireless radio system is configured to detect at least one indication associated with the wireless signal, the at least one indication including detectable content associated with the wireless signal; determine whether the at least one indication associated with the wireless signal identifies the wireless signal as pertinent to an application executing on the computing device; and in response to a determination that the at least one indication identifies the wireless signal as pertinent, communicate an event notice that the wireless signal has been identified.

Alternatively or in addition to the above described computing device, any one or combination of: the radio controller is configured to receive monitoring criteria to start monitoring for the wireless signal having the detected at least one indication; the radio controller is configured to receive monitoring criteria to start monitoring for the wireless signal having the detected at least one indication; the at least one indication comprises the detectable content associated with the wireless signal or a signal strength of the wireless signal, or both; the detectable content associated with the wireless signal comprises a byte pattern in the wireless signal, and the radio controller is further configured to compare the byte pattern to a signal list received from a signal manager of the computing device, wherein to determine that the at least one indication identifies the wireless signal as pertinent at least comprises a determination that the byte pattern is included in the signal list; the radio controller is configured to determine whether the signal strength of the wireless signal is greater than or equal to a signal strength threshold, and wherein to determine that the at least one indication identifies the wireless signal as pertinent further comprises to determine that the signal strength of the wireless signal is greater than or equal to the signal strength threshold; the radio controller is configured to receive the signal list from the signal manager via a hardware interface configured to interface the radio controller with the signal manager; the radio controller is configured to communicate the event notice to the signal manager via the hardware interface effective to activate the signal manager from a power-savings state to process the wireless signal; the radio controller is configured to determine whether a signal strength of the wireless signal is greater than or equal to a signal strength threshold, and wherein to determine that the at least one indication identifies the wireless signal as pertinent at least comprises to determine that the signal strength of the wireless signal is greater than or equal to the signal strength threshold; and a processing system to implement a signal manager that is executable and configured to communicate with the radio controller via a hardware interface configured to interface the radio controller with the signal manager, the signal manager configured to receive the event notice that the wireless signal has been identified, and determine whether to route the wireless signal for use by the application.

A method implemented in a computing device comprises receiving a wireless signal with a wireless radio system in the computing device; determining whether a signal strength of the wireless signal is greater than or equal to a signal strength threshold, the signal strength indicating a proximity of the computing device to a signal source device of the wireless signal; detecting a byte pattern of the wireless signal; determining whether the byte pattern identifies the wireless signal as a wireless signal to be monitored; and in response to determining that the signal strength is greater than or equal to the signal strength threshold and determining that the detected byte pattern identifies the wireless signal as the wireless signal to be monitored, communicating an event notice of the wireless signal being monitored to a signal manager that determines whether to continue monitoring the wireless signal.

Alternatively or in addition to the above described method, any one or combination of: determining whether the wireless signal is pertinent to an application executing on the computing device based on the detected byte pattern of the wireless signal and based on the signal strength of the wireless signal; and wherein the communicating comprises communicating the event notice to the signal manager via a hardware interface configured to interface the signal manager with a radio controller of the wireless radio system, wherein the communicating the event notice is effective to activate the signal manager from a power-savings state to process the wireless signal.

1. A method, comprising:
receiving a wireless signal with a wireless radio system in a computing device;
detecting at least one indication associated with the wireless signal by a radio controller of the wireless radio system, the at least one indication including detectable content associated with the wireless signal;
determining whether the at least one indication associated with the wireless signal identifies the wireless signal as pertinent to an application executing on the computing device; and
in response to determining that the at least one indication identifies the wireless signal as pertinent, communicating an event notice to a signal manager.

2. The method as recited in claim 1, further comprising:
receiving monitoring criteria from the signal manager to start monitoring for the wireless signal having the detected at least one indication.

3. The method as recited in claim 1, wherein the at least one indication comprises the detectable content associated with the wireless signal or a signal strength of the wireless signal, or both.

4. The method as recited in claim 3, wherein:
the detectable content associated with the wireless signal comprises a byte pattern in the wireless signal; and the method further comprises:
comparing the byte pattern to a signal list, wherein the determining that the at least one indication identifies the wireless signal as pertinent at least comprises determining that the byte pattern is included in the signal list.

5. The method as recited in claim 4, further comprising:
determining whether the signal strength of the wireless signal is greater than or equal to a signal strength threshold, and wherein the determining that the at least one indication identifies the wireless signal as pertinent further comprises determining that the signal strength of the wireless signal is greater than or equal to the signal strength threshold.

6. The method as recited in claim 4, further comprising:
receiving the signal list from the signal manager via a hardware interface configured to interface the radio controller with the signal manager.

7. The method as recited in claim 6, wherein the communicating comprises communicating the event notice to the signal manager via the hardware interface effective to activate the signal manager from a power-savings state to process the wireless signal.

8. The method as recited in claim 3, further comprising:
determining whether the signal strength of the wireless signal is greater than or equal to a signal strength threshold, wherein the determining that the at least one indication identifies the wireless signal as pertinent at least comprises determining that the signal strength of the wireless signal is greater than or equal to the signal strength threshold.

9. A computing device, comprising:
a wireless radio system configured to receive a wireless signal;
a radio controller of the wireless radio system configured to:
detect at least one indication associated with the wireless signal, the at least one indication including detectable content associated with the wireless signal;
determine whether the at least one indication associated with the wireless signal identifies the wireless signal as pertinent to an application executing on the computing device; and
in response to a determination that the at least one indication identifies the wireless signal as pertinent, communicate an event notice that the wireless signal has been identified.

10. The computing device as recited in claim 9, wherein the radio controller is configured to receive monitoring criteria to start monitoring for the wireless signal having the detected at least one indication.

11. The computing device as recited in claim 9, wherein the at least one indication comprises the detectable content associated with the wireless signal or a signal strength of the wireless signal, or both.

12. The computing device as recited in claim 11, wherein:
the detectable content associated with the wireless signal comprises a byte pattern in the wireless signal; and the radio controller is further configured to:
compare the byte pattern to a signal list received from a signal manager of the computing device, wherein to determine that the at least one indication identifies the wireless signal as pertinent at least comprises a determination that the byte pattern is included in the signal list.

13. The computing device as recited in claim 12, wherein the radio controller is configured to determine whether the signal strength of the wireless signal is greater than or equal to a signal strength threshold, and wherein to determine that the at least one indication identifies the wireless signal as pertinent further comprises to determine that the signal strength of the wireless signal is greater than or equal to the signal strength threshold.

14. The computing device as recited in claim 12, wherein the radio controller is configured to receive the signal list from the signal manager via a hardware interface configured to interface the radio controller with the signal manager.

15. The computing device as recited in claim 14, wherein the radio controller is configured to communicate the event notice to the signal manager via the hardware interface effective to activate the signal manager from a power-savings state to process the wireless signal.

16. The computing device as recited in claim 9, wherein the radio controller is configured to determine whether a signal strength of the wireless signal is greater than or equal to a signal strength threshold, and wherein to determine that the at least one indication identifies the wireless signal as pertinent at least comprises to determine that the signal strength of the wireless signal is greater than or equal to the signal strength threshold.

17. The computing device as recited in claim 9, further comprising:
a processing system to implement a signal manager that is executable and configured to communicate with the radio controller via a hardware interface configured to interface the radio controller with the signal manager, the signal manager configured to:
receive the event notice that the wireless signal has been identified; and
determine whether to route the wireless signal for use by the application.

18. A method, comprising:
receiving a wireless signal with a wireless radio system in a computing device;
determining whether a signal strength of the wireless signal is greater than or equal to a signal strength threshold, the signal strength indicating a proximity of the computing device to a signal source device of the wireless signal;
detecting a byte pattern of the wireless signal;
determining whether the byte pattern identifies the wireless signal as a wireless signal to be monitored; and
in response to determining that the signal strength is greater than or equal to the signal strength threshold and determining that the detected byte pattern identifies the wireless signal as the wireless signal to be monitored, communicating an event notice of the wireless signal being monitored to a signal manager that determines whether to continue monitoring the wireless signal.

19. The method as recited in claim 18, further comprising:
determining whether the wireless signal is pertinent to an application executing on the computing device based on the detected byte pattern of the wireless signal and based on the signal strength of the wireless signal.

20. The method as recited in claim 18, wherein the communicating comprises communicating the event notice to the signal manager via a hardware interface configured to interface the signal manager with a radio controller of the wireless radio system, wherein the communicating the event notice is effective to activate the signal manager from a power-savings state to process the wireless signal.
